(19) United States
(12) Patent Application Publication
(10) Pub. No.: US 2013/0247078 A1
(43) Pub. Date: Sep. 19, 2013

(54) EMOTICONS FOR MEDIA

(71) Applicants: Andrey N. Nikankin, Sankt-Petersburg (RU); Vsevolod Kuznetsov, Sankt-Petersburg (RU)

(72) Inventors: Andrey N. Nikankin, Sankt-Petersburg (RU); Vsevolod Kuznetsov, Sankt-Petersburg (RU)

(73) Assignee: RAWLLIN INTERNATIONAL INC.

(21) Appl. No.: 13/424,103

(22) Filed: Mar. 19, 2012

(51) Int. Cl. H04N 21/475

(52) U.S. Cl. 725/13

(57) ABSTRACT

Disclosed are systems and techniques that generate a set of measures for one or more users to rate media content. A user, for example, indicates her emotions towards the media content according to one or more various inputs. As inputs are received, the inputs are analyzed and associated with at least one of the set of measures to rate the media content according to an emotion. For example, the set of measures include images that indicate various emotions. These measures are associated with the inputs received from the one or more users, and used to evaluate the media content according to the one or more users emotions detected. Therefore, potential users have additional metrics for evaluating potential media content before purchasing, viewing, interacting with, or sharing the media content.

### TECHNICAL FIELD

The subject application relates to media content and measures related to media content.

### BACKGROUND

Emoticons have historically been used in casual and humorous writing. Digital forms of emoticons can be useful in other types of communications, such as with texting. For example, the emoticons :) or : (are often used to represent happiness or sadness respectively, where : D may indicate gleefulness or extreme joy. The examples do not end here, but nevertheless emoticons are understood to be a pictorial representation of a facial expression expressed using punctuation marks, letters or both that are usually placed on a visual medium to express a person's mood. The word “emoticon” is a portmanteau word of the English words emotion and icon. In web forums, instant messaging forums, online games, etc., text emoticons are often automatically replaced with small corresponding images, which are other forms of emoticons. For example, text marks representing a colon and a closed parenthesis, such as :) that are put in word documents are often automatically replaced with the emoticon: [symbol] regardless of the writer's desire to express such happiness. An August 2004 issue of the Risks Digest pointed to this same problem with such features, which are not under the sender's control:

It's hard to know in advance what character-strings will be parsed into what kind of unintended image. A colleague was discussing his 401k retirement plan with his boss, who happens to be female, via instant messaging. He discovered, to his horror, that the boss's instant-messaging client was rendering the “(k)” as a big pair of red smoochy lips.

Similarly, ratings of various goods, services, entertainment and any media content representing these goods and services are also subject to ambiguous interpretation. In addition, a person often has to spend time interpreting the rating system just to get a general idea of the quality of the rating. For example, ratings for movies or films may be based on a one to five star rating, in which a five star rating represents a well-liked movie and a one star or no star rating represents a disliked movie. However, these ratings are only representative to a certain group of critics, a particular group's likes and dislikes, and the ratings may only be discernable to someone who is familiar with how this particular group of critics rates a movie (i.e., five stars define “best” and one star defines “worst”). Questions remain unanswered. For example, could a four star rating mean that the movie was well financed by a bank that is also rated four stars, or could the meaning be interpreted that the film was great for visual effects, great drama, great plot, etc.? All of these questions and others are inherent to the ratings, unless a person first educates herself to the nature of the rating system being used.

To an individual discerning a rating for a particular media content, with or without an image (e.g., a star or the like), more time is often spent than is needed in trying to select the right media content (e.g., movie, or other content), which may involve the person's mood, taste, desires, etc., such as with a fit wine, a good-fit movie, a good-fit song or some other similar choice. How many times does a person have to stand in front of a Redbox movie rental station watching someone try to pick out a scary movie among two different scary movies, when all that the renter knows is that one movie is considered “horror,” and the other movie is also considered “horror”? The above-described deficiencies of today's rating systems and techniques lend for the need to better serve and target potential users. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and recommending media content are contained herein. An exemplary system comprises a memory that stores computer-executable components and a processor, communicatively coupled to the memory, which facilitates execution of the computer-executable components. The computer-executable components comprise a measuring component configured to generate a set of measures corresponding to media content for one or more users. The computer-executable components further include a selection component configured to select at least one measure from the set of measures based on an input received from the one or more users. Additionally, a rating component is configured to detect an emotion from the input and rate the media content according to the at least one measure selected from the set of measures in response to the emotion detected.

In another non-limiting embodiment, an exemplary method comprises generating, by a system including at least one processor, a set of measures corresponding to media content for one or more users. At least one user is prompted to select at least one measure from the set of measures to rate the media content. The further comprises rating the media content is rated according to the at least one measure selected from the set of measures, wherein the set of measures include pictorially represented emotions.

In yet another non-limiting embodiment, an exemplary method includes generating, by a system including at least one processor, a set of measures corresponding to emotions that rate media content for one or more users with an electronic device. The one or more users are prompted to provide at least one input based on an emotion elicited by the media content. An association of the at least one input is generated with at least one measure of the set of measures. The method further comprises evaluating the media content according to the association.

In still another non-limiting embodiment, an exemplary computer readable storage medium comprising computer executable instructions that, in response to execution, cause a computing system including at least one processor to perform operations. The operations comprise generating a set of measures corresponding to emotions that rate media content for one or more users with an electronic device and prompting the one or more users to provide at least one input based on an emotion elicited by the media content. The operations further comprise generating an association of the at least one input with at least one measure of the set of measures, and evaluating the media content according to the association.

In another non-limiting embodiment, a system is disclosed having means for generating a set of measures corresponding to emotions that rate media content for one or more users; means for receiving an at least one input from the one or more users that indicates at least one emotion related to the media content; means for associating the at least one input with at least one measure of the set of measures; and means for evaluating the media content according to an output of the means for associating.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example recommendation system in accordance with various aspects described herein;

FIG. 2 illustrates another example recommendation system in accordance with various aspects described herein;

FIG. 3 illustrates another example recommendation system in accordance with various aspects described herein;

FIG. 4 illustrates another example recommendation system in accordance with various aspects described herein;

FIG. 5 illustrates an example analyzing component in accordance with various aspects described herein;

FIG. 6 illustrates an example view pane in accordance with various aspects described herein;

FIG. 7 illustrates another example view pane in accordance with various aspects described herein;

FIG. 8 illustrates an example of text icons and meanings in accordance with various aspects described herein;

FIG. 9 illustrates an example of a flow diagram showing an exemplary non-limiting implementation for a recommendation system for evaluating media content in accordance with various aspects described herein;

FIG. 10 illustrates another example of a flow diagram showing an exemplary non-limiting implementation for a recommendation system for evaluating media content in accordance with various aspects described herein;

FIG. 11 is a block diagram representing exemplary non-limiting networked environments in which various non-limiting embodiments described herein can be implemented; and

FIG. 12 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In consideration of the above-described deficiencies among other things, various embodiments are provided that generate ratings for media content, such as films, movies, other video, text, voice, broadcast, internet sites, interactive content and the like. Media content for purposes of this disclosure may also be considered a digital representation of any consumer good, such as a final product intended for consumption rather than for production. For example, media content may be a representation of a book, such as a title name, or the book in digital form, which may, for example, be presented over a network from a server or other client device. By way of another example, food menu items, wines, cars, other goods, and services may also be provided digitally via media content text that represents the good through a name, title, image or some other means, in which embodiments disclosed herein may also generate a rating output or classification in relation to such good and/or service. Services, such as mechanical services, home services, etc., may also be embodied herein for recommendation/rating systems and methods disclosed to measure and classify. The present disclosure is not limited to any particular good, service, and/or particular type of media content. Although, one or more particular goods, services, or media may be referred to, the present disclosure is not limited to any such reference. For example, the term “media content” is intended to mean any type of media (e.g., digital video, text, voice, photo, image, symbol, etc., in real time or non-real time), good and service, in which the good or service may be inherently digital or represented digitally.

To rate media content, a set of measures is generated by exemplary systems and is used to evaluate the media content in order to provide a recommendation. The recommendation, for example, includes a rating that is interpreted by emotions conveyed by one or more users. Users are allowed to specify their emotions in response to media content, such as with emotions felt after viewing a movie. Some media content are categorized as action, adventure, science fiction, horror, romance, etc., or may be critiqued as good or bad on a certain scale. Embodiments herein provide additional perspective according to recommendations for media content based on the user's emotional responses. Emoticons are one example of how users can express emotional responses to media content. Therefore, analyzing, interpreting, and measuring user input that expresses emotions through emoticons or other means of communication can enable additional measures to be provided to the media content, while further affording additional means of expression to users and recommendations to be output from recommendation systems based on the user input.

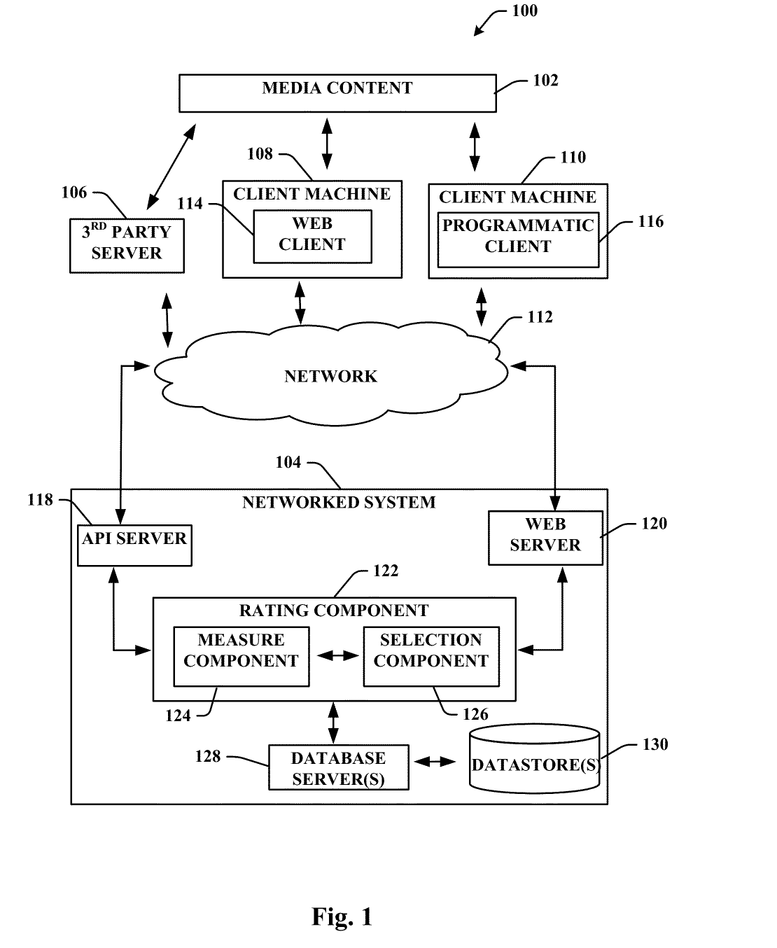

Referring initially to FIG. 1, illustrated is an example system 100 to output one or more recommendations pertaining to media content 102 in accordance with various aspects described herein. The system 100 is operable as a networked recommendation system, such as to recommend various types of media content through ratings assigned to the media content 102. For example, one or more users can provide input that is related to the media content (e.g., a movie, video, book, or the like). The input is received by a networked system 104 configured to analyze input related to the media content 102 and evaluate the media content 102 for users to further use in assessing whether to purchase, consume and/or share the media content 102.

The system 100 includes a networked system 104 that is communicatively connected to one or more servers 106, client machine 108, and/or client machine 110 via a network 112 for receiving user input and communicating the media content 102. A third party server 106, for example, can include different software applications or modules that may host various forms of media content 102 for a user to view, purchase or rate. The third party server 106 can communicate the input received about the media content 102 to the networked system 104 via the network 104, for example, or via a different communication link (e.g., wireless connection, wired connection, etc.). In addition, a client machine 108 or client machine 110 may also enable viewing, interacting or be configured to communicate input related to the media content 102. For example, the client machine 108 has a web client 114 that is also connected to the network 112. The web client 114 may assist in displaying a web page that has media content 102, such as a movie or file for a user to review, purchase, rent, etc. Example embodiments may also include a client machine 110 with a programmatic client 116 that is operatively connected to the network 112 or some other network via a local area network (LAN), wide area network (WAN), cloud network, Internet or other type of network connection, which is referred herein as network 112. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), electronic devices, virtual machine(s), etc. can cause the machine(s) to perform the operations described.

The client machines 108 and 110 may be computer systems or electronic devices with a processor and a memory (not shown). The network is connected to the networked system 104, which is operable as a networked system to provide recommendation output about the media content to other users or the users providing input, such as to third party server 106, client machine 108, client machine 110 or some other electronic device or user device. The server 106, client machine 108 and/or 110, for example can requests various system functions by calling application programming interfaces (APIs) residing on an API server 118 for invoking a particular set of rules (code) and specifications that various computer programs interpret to communicate with each other. The API server 118 and a web server 120 serves as an interface between different software programs, the client machines, third party servers and other devices and facilitates their interaction with the rating component 122 and various components having applications for hardware and/or software. A database server 128 is operatively coupled to one or more data stores 130, and includes data related to various described components and systems described herein.

The rating component 122, for example, is configured to detect an emotion from the inputs provided by various users critiquing the media content 102 and rate the media content according to one or more measures generated by a measuring or measure component 124. The rating component 122 is operable to provide output as a recommendation for the media content 102. The recommendation, for example, may be in the form of an emoticon generated from the input received, or in multiple emoticons that also have various indicators as to the weight of the emotion that conveyed by each emoticon. For example, where multiple users convey inputs that indicates a sad emotion, a sad emoticon may have an weight indication bar that is nearly completely colored, and where only a few users convey a happy emotion, only a slightly colored bar may reside near a happy emoticon. These examples are not limiting and various emoticons, emotions, inputs, and indicators as appreciated by one of ordinary skill in the art can also be used. For example, bars, graphs, charts, lines, percentages, polling statistics, sampling errors, probabilities, and the like could also be used as indicators to various other emoticons other than just a sad emoticon or a happy emoticon.

The rating component includes the measure component 124 and a selection component 126 that is communicatively coupled to the measure component. The measure component 124 is configured to generate a set of measures corresponding to media content for one or more users. The set of measures may be indicative of the type of media content, and the measures of the set of measures can be predetermined or dynamically configured by a logic of the measure component 124 based on the type of media content. Additionally, measures are generated by the measure component 124 as emotions discernable from one or more user inputs received. For example, where the media content 102 is a movie that predictably invokes sadness in the audience of users viewing the movie, a sad face may be received or interpreted from the input and the measure component 124 there generates a sad image as one measure for the set of measures associated with the movie. The sad image may be a sad face, a crying face, etc. that is predetermined and set as a measure by the measure component 124 corresponding to the movie as the media content 102. In addition, for example, the sad face can be generated dynamically by the measure component 124 via an analysis of the media content, establishing the media content is a movie and that sadness prevails within the movie. In response the rating component 122 indicates sadness to the measure component 124, which, in response, generates a sad image as one measure of the set of measures. In addition, for example, the measure component 124 is operable to interpret input received from the one or more users and appropriately assign a sad face as one measure of the set of measures generated for the movie, which may be based on a predetermined number of inputs (e.g., more than two or three) analyzed as indicating sadness, in order to safeguard against false positives for a sad emotion as being received by a user.

The selection component 126 is operatively connected to the measure component 124, and is configured to select at least one measure from the set of measures generated based on the inputs received from the one or more users in relation to the media content. For example, the measure component 124 may generate measures such as images or emoticons indicating sadness, happiness, excitement, surprise, angry, hurt, sleepy, scared, etc. Therefore, the selection component 126 is configured to select one of the emoticons among the set of measures that is closest to the emotion received in the input from users. The selection component 126 further corresponds or associates the measure selected with the media content 102. For example, if sadness is determined from the user inputs, then a sad image from the set of measures is associated with the media content. Multiple associations may be made by the selection component regarding one or more media contents. For example, some inputs received may be associated with a sad emotion, while others with an angry emotion, and, in turn, these inputs can be associated with a sad image and a mad image respectively among the set of measures the media content. Various types of emotions could be interpreted and utilized herein. For example, sad, angry, happy, romantic, greed, lust, hunger, sick, fear, tired, annoyed, drunkenness, dizziness, inquisitive, relieved, confused and the like may all be expressed by users as well as be images or emoticons that are dynamically generated by the measure component 124. The media content, as discussed above, may be a movie, but also the media content may be anything that invokes an emotion, which may be represented by media content, such as with a consumable good and/or a service, which may include various forms of movies or entertainment.

In some embodiments, the systems (e.g., system 100) and methods disclosed herein are implemented with or via an electronic device that generates the set of measures that is a computer, a laptop computer, a router, an access point, a media player, a media recorder, an audio player, an audio recorder, a video player, a video recorder, a television, a smart card, a phone, a cellular phone, a smart phone, an electronic organizer, a personal digital assistant (PDA), a portable email reader, a digital camera, an electronic game, an electronic device associated with digital rights management, a Personal Computer Memory Card International Association (PCMCIA) card, a trusted platform module (TPM), a Hardware Security Module (HSM), a set-top box, a digital video recorder, a gaming console, a navigation device, a secure memory device with computational capabilities, a digital device with at least one tamper-resistant chip, an electronic device associated with an industrial control system, or an embedded computer in a machine, the machine comprising at least one of an airplane, a copier, a motor vehicle, a microwave oven, in the case where a microwave oven is combined with a ratings system for media content, or some other appliance having the same.

In some embodiments, a bus further couples the processor to a display controller, a mass memory or some type of computer-readable medium device, a modem or network interface card or adaptor, and an input/output (I/O) controller. The display controller may control, in a conventional manner, a display, which may represent a cathode ray tube (CRT) display, a liquid crystal display (LCD), a plasma display, or other type of suitable display device. Computer-readable medium may include a mass memory magnetic, optical, magneto-optical, tape, and/or other type of machine-readable medium/device for storing information. For example, the computer-readable medium may represent a hard disk, a read-only or writeable optical CD, etc. A network adaptor card such as a modem or network interface card is used to exchange data across the network 112. The I/O controller controls I/O device(s), which may include one or more keyboards, mouse/trackball or other pointing devices, magnetic and/or optical disk drives, printers, scanners, digital cameras, microphones, etc.

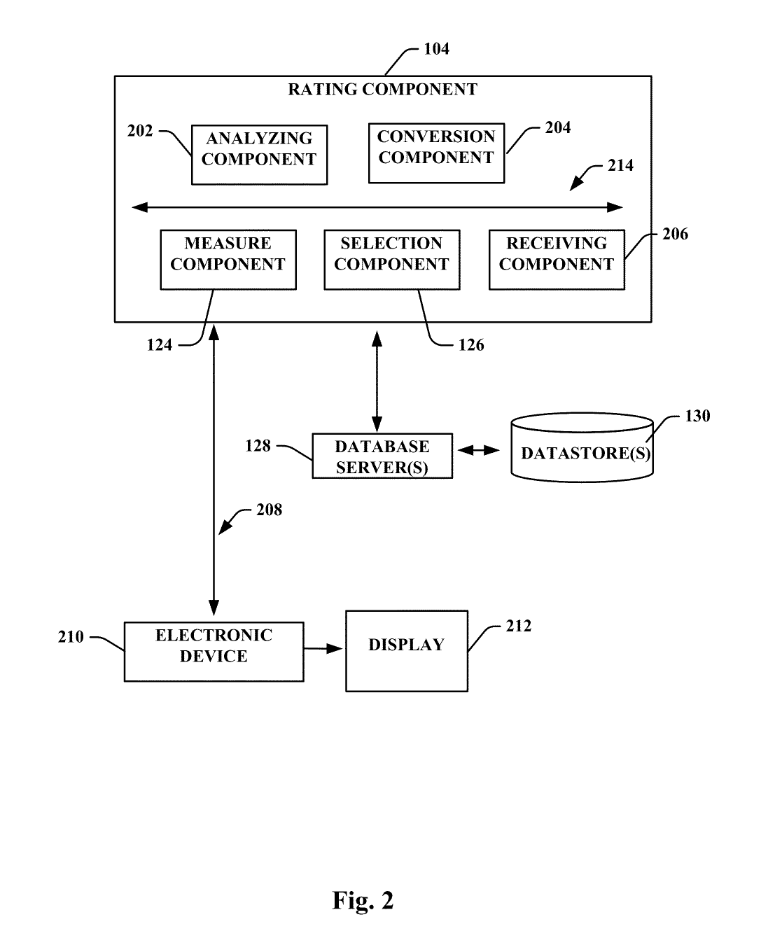

Referring now to FIG. 2, illustrated is an exemplary system that provides ratings for recommendation output to users based on emotions that are elicited from media content in accordance with various aspects described herein. The system includes the rating component 104 that is configured to detect emotions from inputs and rate media content according to the emotions. The rating component 104 includes the measure component 124, the selection component 126, an analyzing component 202, a conversion component 204 and a receiving component 206.

The analyzing component 202 analyzes inputs 208 that are received at an electronic device or from an electronic device 210, such as from a client machine, a third party server, or some other device that enables inputs to be provided from a user. The electronic device 210 may be a cell phone, for example, and the inputs 208 may be from a touch panel that permits a user to input information thereto, such as microphone, keypad, control buttons, a keyboard, a gesture-based device, an optical character recognition (OCR) based device, a joystick, a virtual keyboard, a speech-to-text engine, a mouse, a pen, voice recognition and/or biometric mechanisms, and the like. The analyzing component 202 can receive various inputs and analyzes the inputs for indicators of various emotions being expressed with regard to content media. For example, a text message may include various marks, letters, and numbers intended to express an emotion, which may or may not be discernable without analyzing a store of other texts, or ways of expressing emotions. Further, the way emotions are expressed in text can changed based on cultural language, different punctuations used within different alphabets, for example. The rating component 104 further includes a conversion component 204 that is configured to translate inputs from one or more users into an emotion or measure based on the emotion. The analyzing component 202 is thus operable to discern the different marks, letters, numbers, and punctuation to determine an expressed emotion from the input, such as a text or other input from one or more users in relation to media content.

In a further example, a user may provide an image of a group of individuals or a picture of the user expressing an emotion. The analyzing component 202 is configured to analyze inputs, such as by voice and/or a picture, and determine an emotion being expressed. For example, the analyzing component 202 operates as a facial recognition system that utilizes the database server 128 and data stores 130 as a facial database that stores features to compare facial feature data within in images, such as images captured of faces on a user's phone or other image capturing equipment. As a result, the analyzing component 202 is ascertain what emotions is expressed within the input and eliminate some of the ambiguity and manual work that would be put into analyzing the inputs received. The selection component 126 utilizes the output from the analyzer component 202 and selects a corresponding measure (e.g., an upset image or emoticon) to correspond or associate the selected measure with the media content 102.

The rating component 104 further includes a receiving component 206, which includes a transmitter, receiver or transceiver that receives and transits communications across a network or other communication medium. In some embodiments, the rating component 104 is communicatively connected with a user via a processor or electronic device that operates with input/output controls for providing inputs with one or more emotions related to media content and also to receive recommendations related to any particular media content. In some embodiments, a user can communicate through the receiving component which measure corresponds to the emotion elicited by the media content. For example, the electronic device 210 may host a website through a browser that receives the input directly from the user rather than as a text message, picture, voice command, freehand, digital written image, etc. The user simply selects the measure that includes an image or emoticon of the emotion felt from the media content and thereby manually assigns the measure so that a conversion does not have to occur or a selection from the selection component. The receiving component 206 can process these selections (e.g., manual selections, such as from a user interface and the like) as well as other inputs having text, voice, image, graphic, video data.

Each of the components of the rating component are communicatively coupled via a bus 214, which may further couple a processor of the electronic device 210 and to a display controller of a display 212, a mass memory or some type of computer-readable medium device, a modem or network interface card or adaptor, and an input/output (I/O) controller. The display controller may control, in a conventional manner, the display 212, which may represent a cathode ray tube (CRT) display, a liquid crystal display (LCD), a plasma display, or other type of suitable display device. Computer-readable medium may include a mass memory magnetic, optical, magneto-optical, tape, and/or other type of machine-readable medium/device for storing information. For example, the computer-readable medium may represent a hard disk, a read-only or writeable optical CD, etc. A network adaptor card such as a modem or network interface card is used to exchange data across a network such as an Internet. The I/O controller controls I/O device(s), which may include one or more keyboards, mouse/trackball or other pointing devices, magnetic and/or optical disk drives, printers, scanners, digital cameras, microphones, etc.

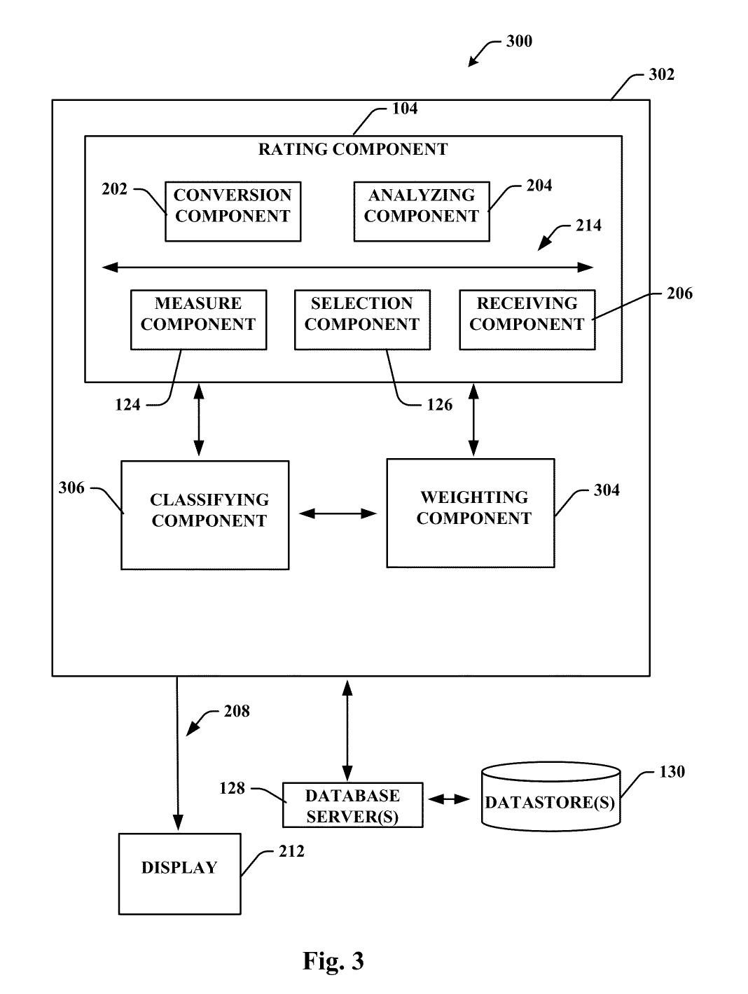

FIG. 3 illustrates exemplary embodiments of a recommendation system 300 that provides recommendations about content media, such as movies, films, etc., in accordance with various aspects described herein. The recommendation system 300 generates assessments based on public perception of a product or service based on emotional responses. Future users are then able to easily critique and express themselves about media content as well as assess various choices based on the emotional responses of other users when making decisions.

The recommendation system 300 includes a recommendation component 306 that includes components similar to the components discussed above. The recommendation component 302 includes a rating component 104 that operates to ascertain a rating from one or more user emotions expressed through inputs received and generate a rating with an emoticon or image that easily conveys an emotion that is associated with the media content. Based on the ratings generated by the rating component 104 (e.g., one or more emoticons indicating an emotion), the recommendation system 302 is configured to dynamically generate an overall assessment or evaluation of media content to users.

The recommendation system 300 further includes a classifying component 302 or a category component 302 that is operable to provide classification to inputs received from one or more users. The classifying component 302 further categorizes one or more measures that are selected based on the inputs received into audience categories. For example, an input that is received by a cell phone text providing a “surprised” emotion (e.g., : O) can be classified according to the user who is communicating the feeling of surprise in relation to a media content (e.g., a movie, television episode, or the like). For example, if the user is a teenager, a media content that is rated with a surprise emoticon (e.g., an image of a person transformed into surprise from the text) would be classified as a teen emotion. In other words, the user or the audience of the content media is used to classify the emoticon rating according to knowledge already known about the user or from knowledge provided by the user, such as with metadata or additional data attributed to the user from a user profile or the like.

The classifying component 306 generates audience categories that can include classifications according to age, gender, religion, race, culture or any number of classifications, such as demographic classifications in which an input that expresses a user's emotion is categorized. In another example, a user could provide an input, such as via text or a captured image from a smart phone of a teary face. If the user has a stored profile, the input could be processed, analyzed and used to provide a measure (e.g., an emoticon image of a sad face) in associated with the book so that other potential readers would understand that at least one user was very sad after reading the book. In addition to having a sad emoticon, an icon designating one or more categories for the user is also generated. The category can be an icon, such as an X for generation X or a Y for generation Y. Further, other icons indicating the age range, interest or audience category (e.g., skater, sports jock, prep, profession, etc.) can accompany the rating. In this fashion, the system 300, for example, receives a number of sad inputs from various different user's, each sad emotion that is interpreted from the inputs can be counted by a counter and then the sad emoticon generated can be weighted accordingly with one or more audience classification icons that further identify the group of user's providing the inputs.

The recommendation component 302 further includes a weighting component 304 that is communicatively connected to the classifying component 306. The weighting component 304 is operable to generate a set of weight indicators that indicate weighted strengths for the set of measures generated by the measure component 124. For example, weight indicators can include, but are not limited to, bars, graphs, charts, lines, percentages, polling statistics, sampling errors, probabilities, and the like. For example, where the set of measures include various emoticons, the weight indicators generated from the weighting component provide a weight indication as to the strength of the measure. In one example, a happy emoticon is a measure that could be determined as a corresponding measure to the input for emotion received from a user rating a movie. However, while this particular movie (e.g., “Streets of Fire”) elicited a happy emotion as expressed by the user, the same movie could elicit an angry emotion expressed by another user who has viewed the movie. Further, multiple users could provide inputs corresponding to happy and/or angry. Therefore, recommending the movie based on user inputs would not be entirely accurate if the recommendation only included happy emoticons or angry emoticons as measures.

In one embodiment, the weighting component 304 is configured to generate weighting indicators as icons associated with a measure of a set of measures. For example, where multiple users convey inputs that indicates a sad emotion, a sad emoticon may have a weight indication bar that is nearly completely colored based on a percentage of users providing their emotional input regarding media content via voice, text, image, graphic, photo, etc. For example, where only a few users convey a happy emotion, only a slightly colored bar may reside near a happy emoticon. In one example, the weighting indicator represents a poll of users and operates as a voting function, so that some measures (e.g., a happy emotion and a sad emotion) are provided percentages or levels. Additionally, the weighting indicators can be configured to provide a level of intensity that an emotional response is generated from media content, in which may be expressed through different colors can be assigned to each measure selected. These examples are not limiting and various emoticons, emotions, inputs, and indicators as appreciated by one of ordinary skill in the art can also be used.

In other embodiments, the recommendation component 302 of the recommendation system 300 provides the media content, such as via a website or via a network to users. The users may select the measure (e.g., caption, image or emoticon) or indicate directly their emotion as the best indicator of their emotion. Alternatively, users can select multiple emotions and rate them in an order of priority so that weight indicators from the weighting component 304 are also weighted on based on a statistical curve that indicates priority strength of the weight indicator. For example, a bell curve, Gaussian curve, etc., could be utilized with a priority rating for each measure and a corresponding weight indicator, such as a percentage or the like, as discussed above.

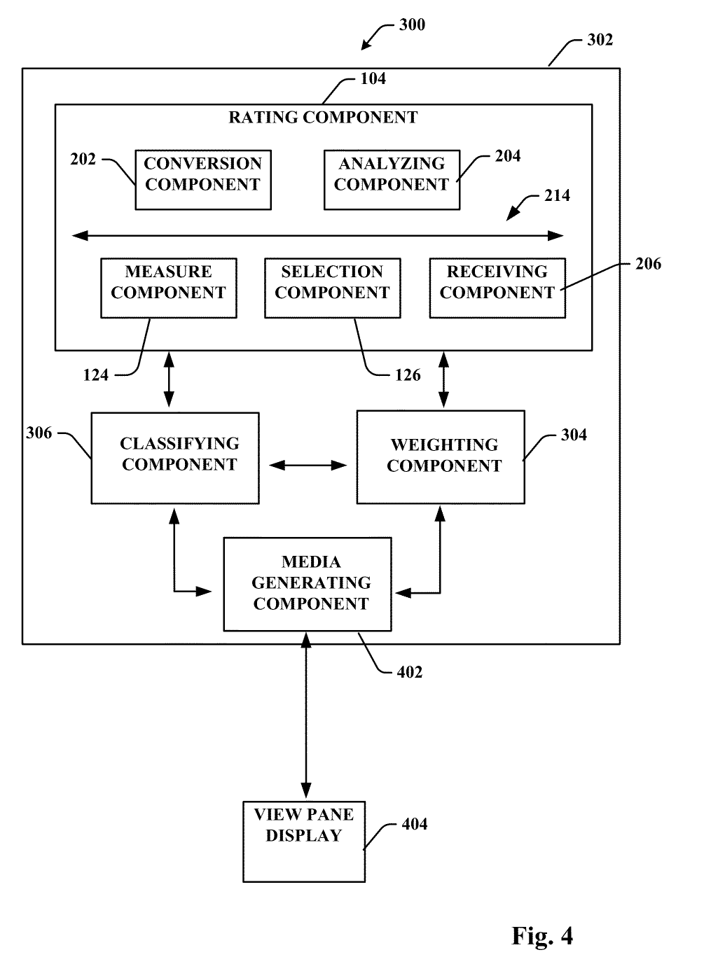

Referring now to FIG. 4, illustrated are further exemplary aspects of the exemplary system 300 that provides ratings for recommendation output to users based on input expressing emotions elicited from media content. The recommendation component 302 comprises a media generating component 402 and a view pane display 404 communicatively coupled to one another.

The media generating component 402 is configured to provide media content to a user. For example, the media content can be a movie or film that is streamed online to the user for viewing from a website. In other example, the movie could be provided to the user over a television network through a television. As discussed above, any number of electronic devices could be used by the user to view the media content, and in which the system 300 is in communication with to transmit the media content.

The recommendation component 302 further includes a view pane 404 that is configured to generate a user interface and a viewing screen for users critiquing, providing input, logging on to an account, creating a profile, viewing other responses to make a media content selection, which are based on the emotional responses to the media content. The media generating component 402 is operable as a display component that generates a display in the view pane 404 for users to interface with various selections and to display the media content. For example, the media generating component 402 is configured to display at least one measure of the set of measures with a weight indicator, an audience category, and other elements such as a priority indicator, which is further discussed below.

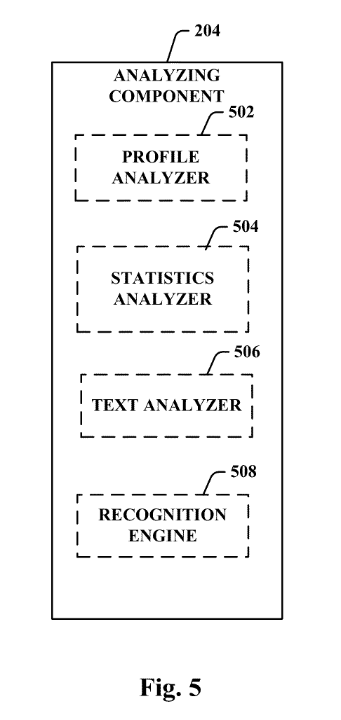

Referring now to FIG. 5, illustrated is the analyzing component 204 in accordance with various aspects described herein. The analyzing component 204 includes a profile analyzer 502, a statistics analyzer 504, a text analyzer 506 and a recognition engine 508 that are configured to analyze inputs received to determine an emotional response from one or more users.

The profile analyzer 502 can prompt a user to provide at least one input based on emotions elicited by the media content. The profile analyzer 502 is further configured to receive information associated with one or more users in order to generate and store a user profile. Information about the user providing emotional input about the media content is stored and categorized in order to provide audience categories according to demographic information, such as generation (e.g., gen X, baby boomers, etc.), race, ethnicity, interests, age, educational level, and the like. User profiles can be used by the profile analyzer 502 to compare various user profiles generating emotional response to particular media content.

The statistics analyzer 504 is configured to generate statistics related to the various user profiles corresponding to different inputs being received by the analyzing component 204 associated with media content. For example, different graphs or charts can be generated by the profile analyzer to display demographics of emotional inputs about a movie. These graphs can be compared by the statistics analyzer 504 to generate percentages, or weights for different categories of audiences (e.g., one or more users viewing the movie) according to the measures (e.g., emoticons, images or the like) generate for the movie. For example, a percentage of Asians may show great joy towards a violent film, as opposed to a different ethnicity, nationality, age group, etc. may show disgust or horror due to the films gruesome character. However, some users from different groups may overlap to show similar emotions in the input responses, especially, for example, where the movie was good in some aspects and certain emotions could become overlooked although still inputted as multiple different emotions. In addition, some user may favor a certain emotion over other users who may not. Horror could bring some happiness, while others sadness or disgust. Further, some age groups may favor one type of emotional response over other age groups, in which some responses may be similar among the age groups even though the majority of inputs provided from each of the age groups are different (e.g., happy in a first age group, and sad in another second age group).

The text analyzer 506 is configured to analyze text inputs that are received from users in order to decipher certain features from the text relating to the user's profiles or to decipher certain emoticons in text so that the emoticons converted to a different second emoticon that is an image or an emoticon better expressing visual emotion relating to the media content. A recognition engine 508 is configured to recognize facial features and voice recognition elements from the inputs received from various users. For example, a user can capture an image of themselves or of a group of users after viewing a movie in order to provide the emotional inputs to the system. The recognition engine 508 is configured to automatically identify or verify a person (e.g., user) and their facial expressions from a digital image or a video frame from a video source. In one embodiment, the recognition engine 508 does this by comparing selected facial features from the image and a facial database with a recognition algorithm, such as with the data stores 130, discussed above. The recognition algorithms, for example, can be divided into two main approaches, geometric, which examine distinguishing features, or photometric, which is a statistical approach that distills an image into values and comparing the values with templates to eliminate variances. The recognition algorithms include Principal Component Analysis using Eigen values, Linear Discriminate Analysis, Elastic Bunch Graph Matching using the Fisherface algorithm, the Hidden Markov model, and the neuronal motivated dynamic link matching algorithm.

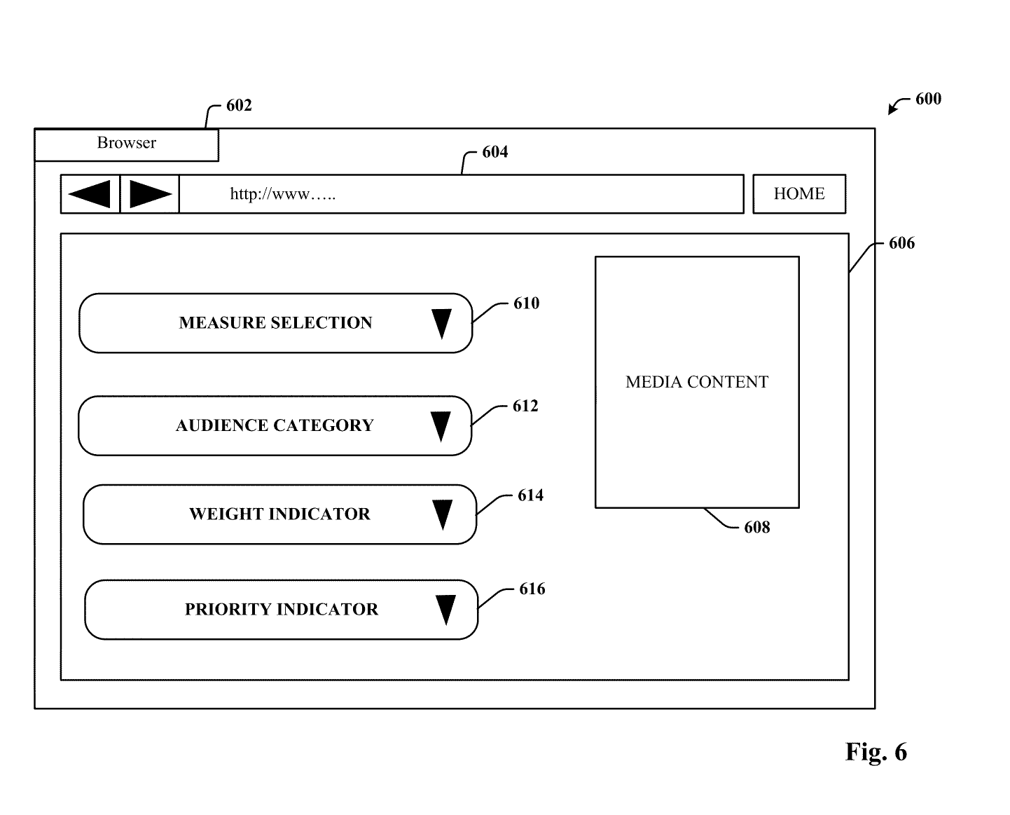

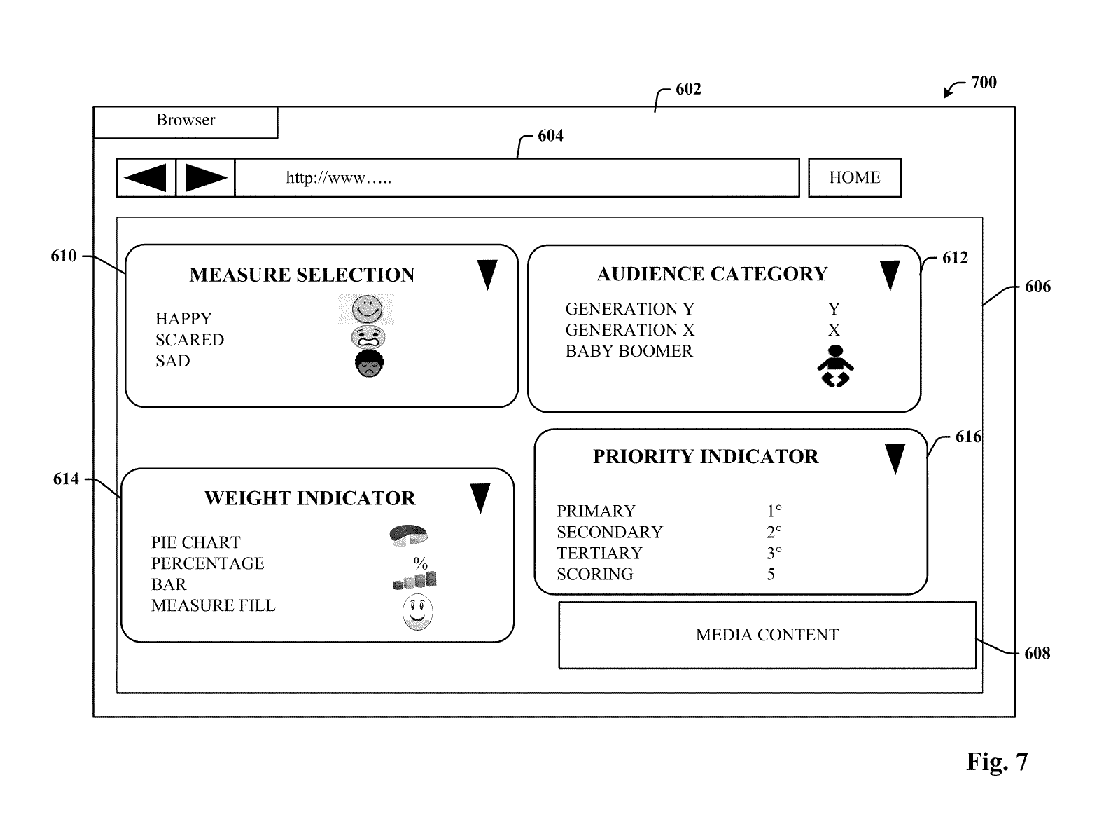

FIGS. 6 and 7 are described below as representative examples of aspects disclosed herein of one or more embodiments. These figures are illustrated for the purpose of providing examples of aspects discussed in this disclosure in viewing panes for ease of description. Different configurations of viewing panes are envisioned in this disclosure with various aspects disclosed. In addition, the viewing panes are illustrated as examples of embodiments and are not limited to any one particular configuration.

Referring now to FIG. 6, illustrated is an example input viewing pane 600 in accordance with various aspects described herein. As discussed previously, the media generating component 402 generates displays for a viewing pane. In embodiment, a user can enter selections via a user interface, such as through a shopping portal or other portal on an online site for purchases items or local services, such as expressed by media content. The viewing pane 600 can be associated via a web browser 602 that includes an address bar 604 (e.g., URL bar, location bar, etc.). The web browser 602 can expose an evaluation screen 606 that includes media content 608 for viewing either directly over a network connection, or some other connection, or for evaluation as media content that is representative of the good, service or entertainment that is being evaluated by a user.

The screen 606 further includes various graphical user inputs for evaluating the media content 608 by manual or direct selection online. The screen 606 comprises a measure selection control 610, an audience category control 612, a weight indicator control 614, and a priority indicator control 616. Although the controls generated in the screen 606 are depicted as drop down menus, as indicated by the arrows, other graphical user interface controls. For example, buttons, slot wheels, check boxes, icons or any other image enabling a user to input a selection at the screen. Theses controls enable a user to log on or enter a website via the address 604 and provide input having their emotional responses via a selection.

Referring now to FIG. 7, illustrated is an example of the different items displayed in the screen 606 in accordance with various aspects described herein. Further, although these items are displayed for selection, these examples are also provided to illustrated the different measures, weight indicators, audience categories, priority indicators that are generated in conjunction with the above discussed components or elements of the disclosed recommendation systems. For example, a user can thus provide inputs expressing emotion to media content via a user interface selection, a text, a captured image, a voice command, a video, a free form image, a digital ink image, a handwritten digital image and/or the like.

In one embodiment, the measure selection control 610 has different predetermined emoticons associated with an emotion. These emoticons or images can be dynamically generated by the measure component discussed above, be predetermined, and/or generated based on inputs analyzed for different emotional responses, such as a happy face text, or a picture of user smiling, voice recognition of the word “happy”, and the like, for example. Other such measures can also be viewed or generated as well. In one embodiment, features related to a user or person's profile can also be used to generate the emoticon. For example, where an African or Asian user is known by the system to be providing a sad emotion, a sad face can be generated that indicates a person having similar features. In addition, the gender of the user person can be expressed in the emoticon. Other demographic features expressed herein may also be used to express an emoticon or an emotional measure for the media content. The different user profiles and features associated with an emoticon or image measure can be predetermined via the controls on the screen 606 by users. Therefore, users can evaluate a movie or any media content anonymously or according to their own settings.

In other further embodiments, the audience indicator control 612 is configured to provide icons related to difference audience categories or classifications, which are discussed above. For example, where the demographic of users is expressed or associated with the measures according to generation, then icons related to or identifying each generation within a culture may also be expressed with the rating. For example, “Generation X” could be expressed as X, “Generation Y” could be expressed as Y and the generation in the United States that includes “Baby Boomers” could be expressed with a baby icon, in order to more fully provide the demographics of the different emoticons being generated.

In other embodiments, the weight indicator control 614 provides various options for indicating a weight of a set of measures or of particular measures that are received. For example, a group of users providing emotional ratings of a movie could have different emotions, which are expressed according to a pie chart, a percentage, a bar, or a measure fill, or some other indicator that indicates a weight of the particular emoticon rating. For example, the happy emoticon may be expressed by fifty percent of users providing input, while the scared emoticon is expressed by 20 percent, and the sad emoticon is expressed by 20% also. Therefore, the three different expressions this particular movie elicits more commonly in users would happy, scared, and sad with a weight indicator associated with each to show the range of emotions and weight of each. The responses could be associated with a poll of all users, for example, that is expressed by the weight indicators.

In other embodiments, the priority indicator control 616 provides different priority indicators that can be generated, selected as a setting, and/or predetermined. For example, where inputs are received about a movie from the group of users discussed above, a movie could also elicit multiple responses from a user. For example, a user watching the movie could have a complexity of emotions ranging from sad, delightful, peaceful, angry and thoughtful all at once. Therefore, different priorities could also be ascertained from the captured images, text, voice, user selections, etc. and each input analyzed could be weighted with an average weight, a median weight or some other statistical measure that is calculated with the statistics analyzer 504 of the analyzer component 204, for example. For example, a user may give certain priorities to different inputs or selections corresponding to the media content. Therefore, users expressing happiness as a certain percentage could also have a weight given to this input based on if this is the primary emotion expressed among multiple emotions expressed by one user. Therefore, a potential user evaluating the media content would view a happy emoticon having fifty percent that is weighted with a primary, secondary or tertiary rating, which is more heavily expressed from those users already having evaluated this media content with their emotions. Alternatively, a scoring could be expressed and used in the weighing of the emoticon and weight indicators, such as a five, for example. Therefore, fifty percent of users feel happy by the media content, as and a five (e.g., on a scale of 1 to 10) could indicate that half of the fifty percent of users provided this as their most dominant emotion felt, but other emotions were also elicited, for example. Therefore, the priority indicator gives a strength indication to the accuracy of the measure selections and weight indicators to gauge the emotion elicited by the media content.

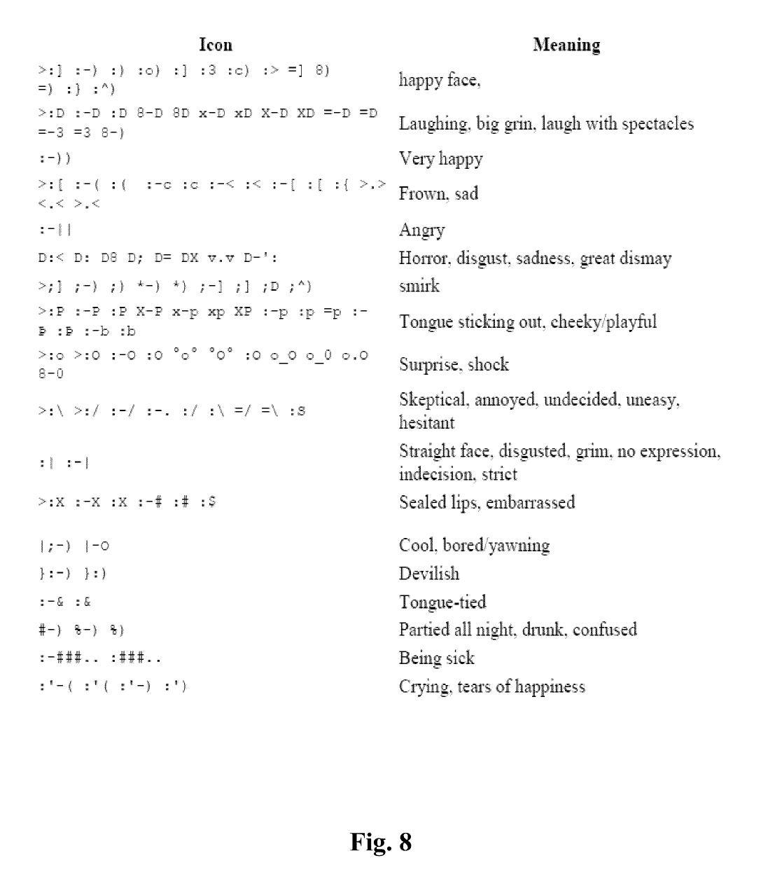

FIG. 8 illustrates different icons that could be received from a text in accordance with various aspects disclosed herein. The right column provides icons that a user could text to a certain number or website to provide their emotion elicited or caused by the media content. The right column gives the interpretation of the emotion analyzed from the text via the text analyzer 506, for example. These emotions could be associated through a storage memory or other emotions could be dynamically interpreted from the text.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

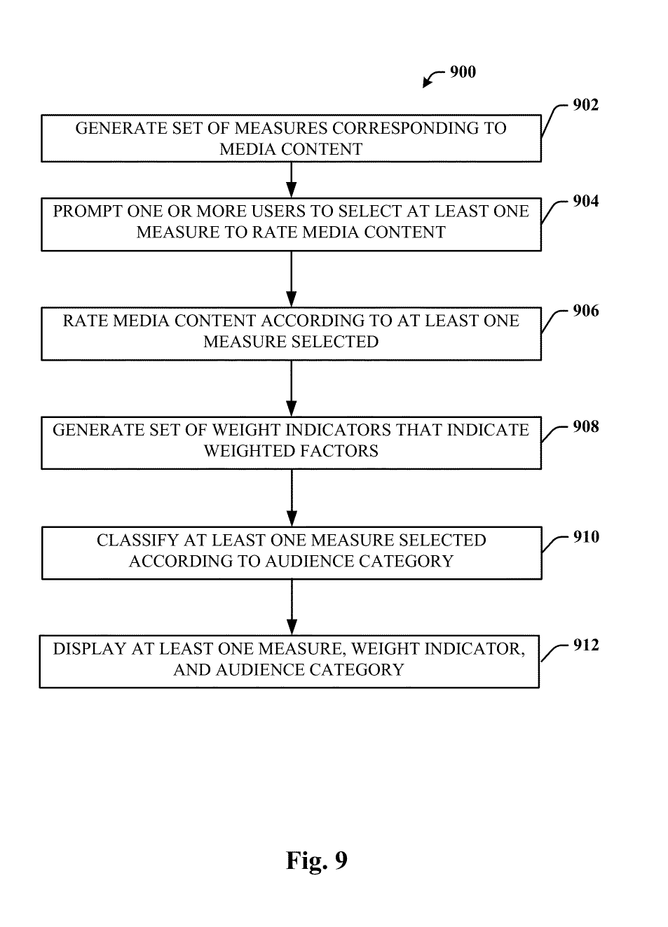

An example methodology 900 for implementing a method for a recommendation system is illustrated in FIG. 9. Reference is made to the figures described above for ease of description. However, the method 900 is not limited to any particular embodiment or example provided within this disclosure.

FIG. 9 illustrates the exemplary method 900 for a system in accordance with aspects described herein. The method 900, for example, provides for a system to interpret inputs received expressing emotions of one or more users from media content. An output or recommendation can be provided based on analysis of the received inputs with emotions. In addition, users are provided an additional perspective for evaluating goods and services, such as entertainment, and determining whether to purchase, view, share, or otherwise participate in various media content.

At 902, the method beings with generating a set of measures that correspond to media content. As discussed above, a measure component, for example, generates various measures according to a predetermined selection, a user input, and/or dynamically in response to analysis of user inputs expressing emotion elicited by the media content. For example, a set of measures is generated according to the type of movie, book, or some other good or service expressed as media content. In some embodiment, the media content is analyzed by the analyzer component discussed herein for emotions. In response to this analysis, a set of measures including emoticons or images of emotions that are expressed within the content could be dynamically generated. The set of measures can include various emoticons displaying emotions or images that represent emotions caused by the media content.

At 904, one or more users are prompted to select at least one measure to rate media content according to the emotion that the media content caused. For example, a sad face could be selected from the set of measures to indicate that the user feels sad after watching the particular movie, reading a particular book, etc. At 906, the inputs received by the users are analyzed and the media content is rated according to at least one measure selected. A movie, for example, is associated with a sad face thereafter. However, if no one expresses sadness then no sad faces would necessarily be associated with the movie. In other embodiments, all of the measures of the set of measures are associated with a movie and then rated according to various strength scores or indicators.

At 908, a set of weight indicators are generated that indicate weight factors that respectively correspond with the set of measures. Each weight indicator could provide the strength of the particular measure associated with the media content. For example, a happy face may have a 75% rating associated with the happy face emoticon and the movie or content media. Other emoticons could be generated as the set of measures or other images indicating emotions. For example, a romantic desire could be indicated by a heart or valentine day symbol. Various weight indicators are envisioned as discussed above, such as with percentages, bars, graphs, charts, strength indicators or fill emoticons where half the measure generated or a portion corresponding to the number of users expressing a particular emotions indicated by the emoticon could be generated.

At 910, at least one measure selected by the recommendation system is classified according to an audience classification or category, such as with a demographic classification including age, ethnicity, religion, gender, race, citizenship, generation, etc. At 912, at least one measure of the set of measures is displayed by a display component that provides a strength of the at least one measure to gauge an emotion response from the media content within the audience category. Thus, a person discerning whether to purchase a particular movie could evaluate how many people expressed a certain emotional response to the movie or media content according to an audience category. For example, a happy face that is half full next to a baby would indicate that half of baby boomers providing emotional responses or inputs to this media content are happy feeling after viewing the movie.

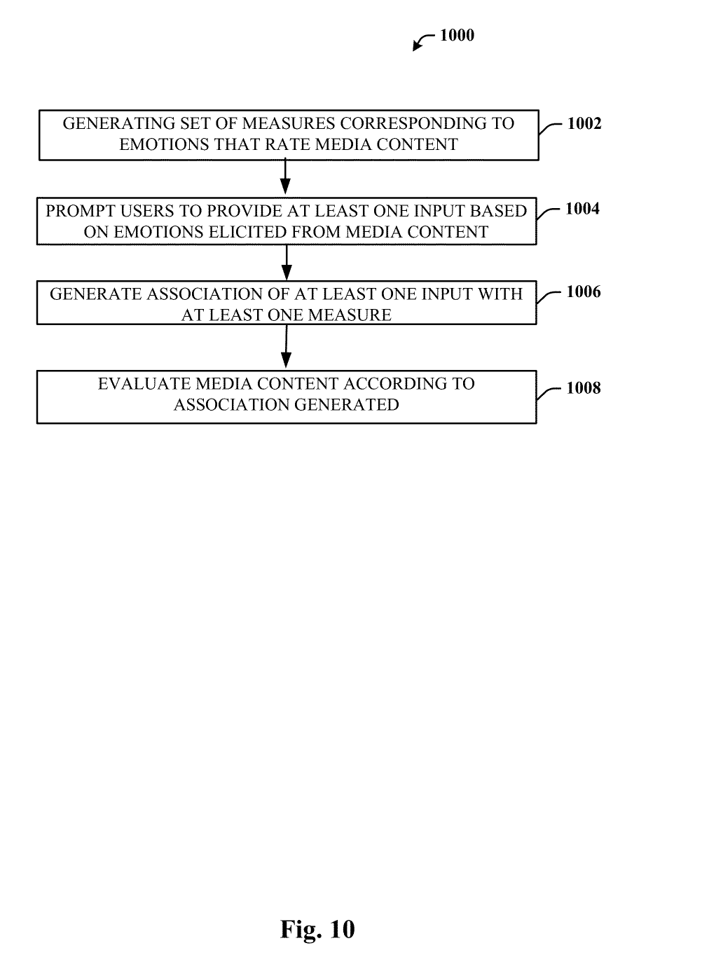

An example methodology 1000 for implementing a method for a system such as a recommendation system for media content is illustrated in FIG. 10. Reference may be made to the figures described above for ease of description. However, the method 1000 is not limited to any particular embodiment or example provided within this disclosure.

The method 1000, for example, provides for a system to evaluate various media content. At 1002, a set of measures is generated that correspond to emotions to rate media content. After receiving a service, entertainment and/or good, such as a movie being viewed, a user may provide input that includes his or her emotion or emotional response to the media content. For example, a user could text message, select via GUI controls, provide a voice command, photo, other captured image, freeform drawing, digital ink message, etc. to express an emotion to the media content. At 1004, users are prompted (e.g., at a display) to provide at least on input based on emotions elicited from the media content. At 1006, the system generates an association of the at least one input with at least one measure of the set of measures. For example, where a colon and a closed parenthesis are received, the system will translate this into a happy emoticon as one of the measures evaluating the movie or media content. A happy face is then associated with the media content for future or potential users to evaluate the movie as a viable candidate for viewing at home or elsewhere. At 1008, the media content is evaluated according to the association generated.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

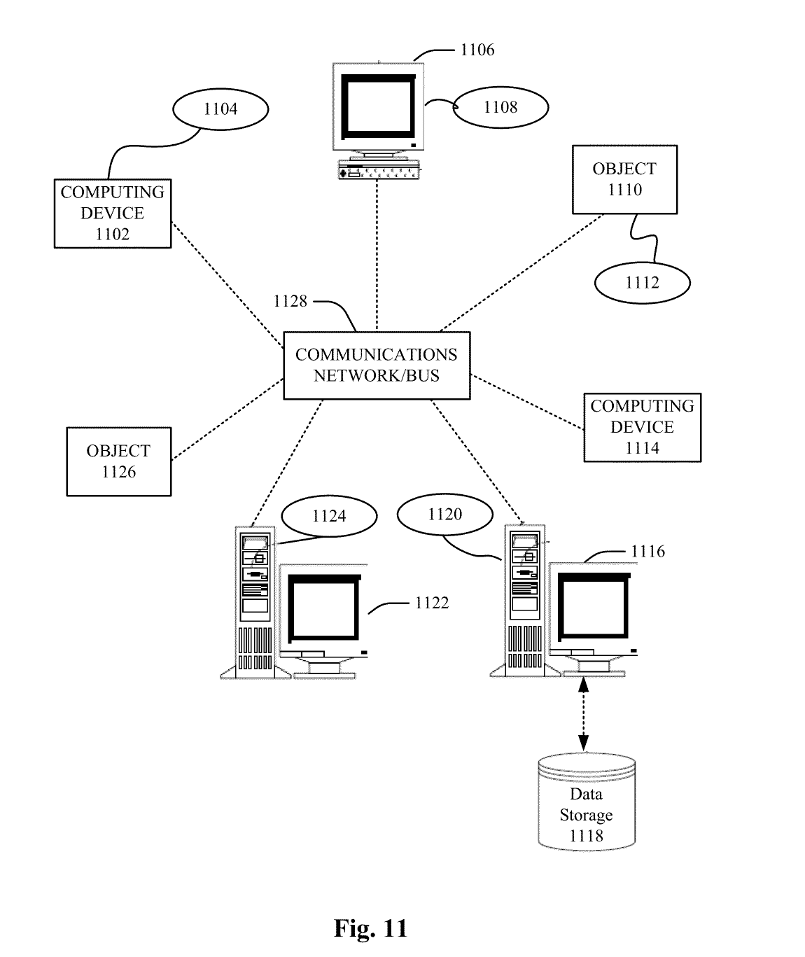

FIG. 11 provides a schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that computing objects 1110, 1112, etc. and computing objects or devices 1120, 1122, 1124, 1126, 1128, etc. may comprise different devices, such as personal digital assistants (PDAs), audio/video devices, mobile phones, MP3 players, personal computers, laptops, etc.

Each computing object 1110, 1112, etc. and computing objects or devices 1120, 1122, 1124, 1126, 1128, etc. can communicate with one or more other computing objects 1110, 1112, etc. and computing objects or devices 1120, 1122, 1124, 1126, 1128, etc. by way of the communications network 1140, either directly or indirectly. Even though illustrated as a single element in FIG. 11, communications network 1140 may comprise other computing objects and computing devices that provide services to the system of FIG. 11, and/or may represent multiple interconnected networks, which are not shown. Each computing object 1110, 1112, etc. or computing object or device 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 11, as a non-limiting example, computing objects or devices 1120, 1122, 1124, 1126, 1128, etc. can be thought of as clients and computing objects 1110, 1112, etc. can be thought of as servers where computing objects 1110, 1112, etc., acting as servers provide data services, such as receiving data from client computing objects or devices 1120, 1122, 1124, 1126, 1128, etc., storing of data, processing of data, transmitting data to client computing objects or devices 1120, 1122, 1124, 1126, 1128, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1140 or bus is the Internet, for example, the computing objects 1110, 1112, etc. can be Web servers with which other computing objects or devices 1120, 1122, 1124, 1126, 1128, etc. communicate via any of a number of known protocols, such as the hypertext transfer protocol (HTTP). Computing objects 1110, 1112, etc. acting as servers may also serve as clients, e.g., computing objects or devices 1120, 1122, 1124, 1126, 1128, etc., as may be characteristic of a distributed computing environment.

### Exemplary Computing Device

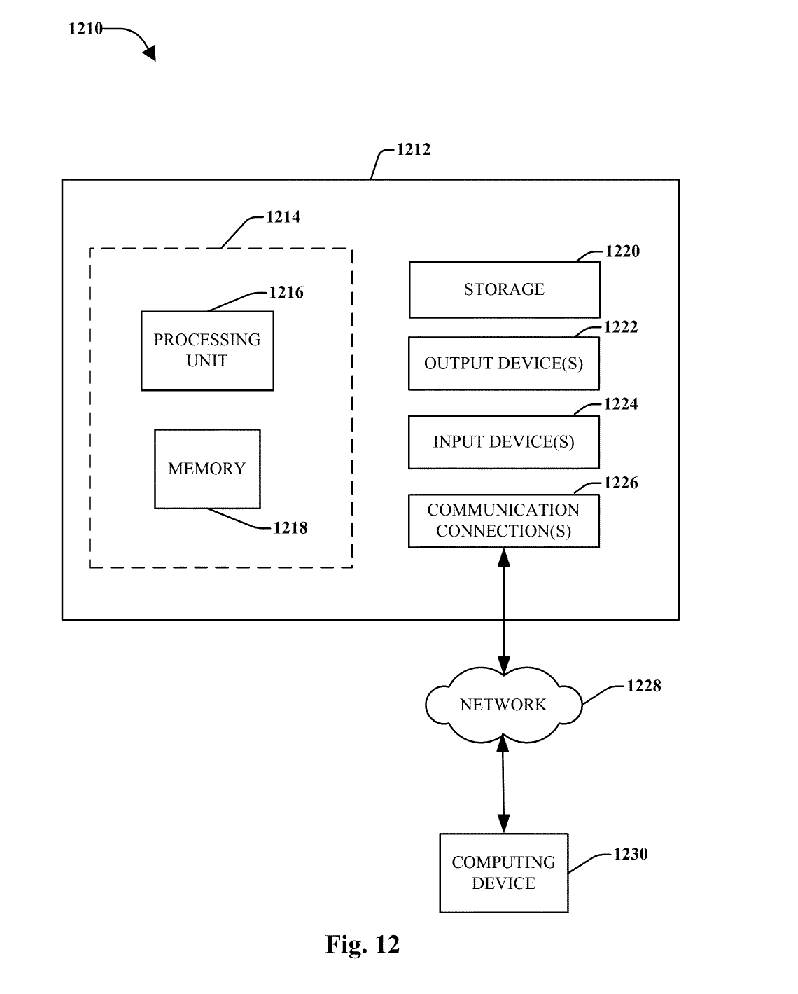

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 12 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 12 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 1210 comprising a computing device 1212 configured to implement one or more embodiments provided herein. In one configuration, computing device 1212 includes at least one processing unit 1216 and memory 1218. Depending on the exact configuration and type of computing device, memory 1218 may be volatile (such as RAM, for example), non-volatile (such as ROM, flash memory, etc., for example) or some combination of the two. This configuration is illustrated in FIG. 12 by dashed line 1214.

In other embodiments, device 1212 may include additional features and/or functionality. For example, device 1212 may also include additional storage (e.g., removable and/or non-removable) including, but not limited to, magnetic storage, optical storage, and the like. Such additional storage is illustrated in FIG. 12 by storage 1220. In one embodiment, computer readable instructions to implement one or more embodiments provided herein may be in storage 1220. Storage 1220 may also store other computer readable instructions to implement an operating system, an application program, and the like. Computer readable instructions may be loaded in memory 1218 for execution by processing unit 1216, for example.

The term “computer readable media” as used herein includes computer storage media. Computer storage media includes volatile and nonvolatile, removable and non-removable media implemented in any method or technology for storage of information such as computer readable instructions or other data. Memory 1218 and storage 1220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1212. Any such computer storage media may be part of device 1212.

Device 1212 may also include communication connection(s) 1226 that allows device 1212 to communicate with other devices. Communication connection(s) 1226 may include, but is not limited to, a modem, a Network Interface Card (NIC), an integrated network interface, a radio frequency transmitter/receiver, an infrared port, a USB connection, or other interfaces for connecting computing device 1212 to other computing devices. Communication connection(s) 1226 may include a wired connection or a wireless connection. Communication connection(s) 1226 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1218 and storage 1220 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer readable storage media may be part of device 1212.

Device 1212 may also include communication connection(s) 1226 that allows device 1212 to communicate with other devices. Communication connection(s) 1226 may include, but is not limited to, a modem, a Network Interface Card (NIC), an integrated network interface, a radio frequency transmitter/receiver, an infrared port, a USB connection, or other interfaces for connecting computing device 1212 to other computing devices. Communication connection(s) 1226 may include a wired connection or a wireless connection. Communication connection(s) 1226 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1212 may include input device(s) 1224 such as keyboard, mouse, pen, voice input device, touch input device, infrared cameras, video input devices, and/or any other input device. Output device(s) 1222 such as one or more displays, speakers, printers, and/or any other output device may also be included in device 1212. Input device(s) 1224 and output device(s) 1222 may be connected to device 1212 via a wired connection, wireless connection, or any combination thereof. In one embodiment, an input device or an output device from another computing device may be used as input device(s) 1224 or output device(s) 1222 for computing device 1212.

Components of computing device 1212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1212 may be interconnected by a network. For example, memory 1218 may be comprised of multiple physical memory units located in different physical locations interconnected by a network.

Those skilled in the art will realize that storage devices utilized to store computer readable instructions may be distributed across a network. For example, a computing device 1230 accessible via network 1228 may store computer readable instructions to implement one or more embodiments provided herein. Computing device 1212 may access computing device 1230 and download a part or all of the computer readable instructions for execution. Alternatively, computing device 1212 may download pieces of the computer readable instructions, as needed, or some instructions may be executed at computing device 1212 and some at computing device 1230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components;
a processor, communicatively coupled to the memory, that facilitates execution of the computer-executable components, the computer-executable components including:
a measuring component configured to generate a set of measures corresponding to media content for one or more users;
a selection component configured to select at least one measure from the set of measures based on an input received from the one or more users;
a rating component configured to detect an emotion from the input and rate the media content according to the at least one measure selected from the set of measures in response to the emotion detected.

2. The system of claim 1, further comprising:
a receiving component configured to receive the input from the one or more users that evaluates the media content according to the emotion of the one or more users.

3. The system of claim 1, further comprising:
a conversion component that translates the input from the one or more users into the at least one measure selected based on the emotion detected.

4. The system of claim 1, wherein the set of measures includes pictorially represented emoticons.

5. The system of claim 1, wherein the input received includes a user interface selection, a text, a captured image, a voice command, a video, or a freeform image, that evaluates the media content according to the emotion of the one or more users caused by the media content.

6. The system of claim 1, further comprising:
a weighting component configured to generate a set of weight indicators that indicate weighted strengths for the set of measures.

7. The system of claim 6, wherein one or more weight indicators of the set of weight indicators indicates a weighted strength for a measure of the set of measures according to an accuracy of the measure to gauge the emotion in association with the media content.

8. The system of claim 1, further comprising:
a category component configured to classify the input received from the one or more users and classify the at least one measure selected based on the input, wherein the at least one measure is classified according to an audience category for a demographic of the one or more users.

9. The system of claim 8, further comprising:
a display component that displays the at least one measure of the set of measures with a weight indicator that provides a strength of the at least one measure based on an accuracy of the at least one measure to gauge the emotion related to the media content of the audience category.

10. A method, comprising:
generating, by a system including at least one processor, a set of measures corresponding to media content for one or more users;
prompting the one or more users to select at least one measure from the set of measures to rate the media content; and
rating the media content according to the at least one measure selected from the set of measures;
wherein the set of measures include pictorially represented emotions.

11. The method of claim 10, further comprising:
receiving an input from the one or more users that selects the at least one measure and evaluates the media content according to an emotion of the one or more users.

12. The method of claim 11, wherein the input received includes a user interface selection, a text, a captured image, a voice command, a video, or a freeform image, that evaluates the media content according to the emotion of the one or more users caused by the media content.

13. The method of claim 11, wherein generating the set of measures includes generating a set of emoticons that are selected according to the input received.

14. The method of claim 13, wherein the set of emoticons include at least one of a sad face, a happy face, a scared face, an angry face, an annoyed face, a humorous face, and a proud face.

15. The method of claim 11, wherein the input received includes a captured image of the one or more users indicating the emotion.

16. The method of claim 11, further comprising:
analyzing the input received to associate the input with the at least one measure to select the at least one measure from the set of measures.

17. The method of claim 10, further comprising:
generating a set of weight indicators that respectively indicate weighted factors for the set of measures, wherein the set of measures include emoticons.

18. The method of claim 17, further comprising:
generating a set of icons that represent at least one category of an audience; and
classifying the emoticons selected from an input received from the one or more users according to the set of icons.

19. The method of claim 10, further comprising:
classifying the at least one measure according to an audience category for a demographic of the one or more users; and
displaying, in a display component, the at least one measure of the set of measures with a weight indicator that provides a strength of the at least one measure to gauge an emotion response from the media content within the audience category

20. A method, comprising:
generating, by a system including at least one processor, a set of measures corresponding to emotions that rate media content for one or more users with an electronic device;
prompting the one or more users to provide at least one input based on an emotion elicited by the media content;
generating an association of the at least one input with at least one measure of the set of measures; and
evaluating the media content according to the association.

21. The method of claim 20, wherein the set of measures include emoticons that pictorially indicate the emotion caused by the media content in the one or more users.

22. The method of claim 20, wherein the generating the set of measures corresponding to the emotions that rate the media content for the one or more users with the electronic device comprises generating the set of measures with the electronic device that is one of a computer, a laptop computer, a router, an access point, a media player, a media recorder, an audio player, an audio recorder, a video player, a video recorder, a television, a smart card, a phone, a cellular phone, a smart phone, an electronic organizer, a personal digital assistant (PDA), a portable email reader, a digital camera, an electronic game, an electronic device associated with digital rights management, a Personal Computer Memory Card International Association (PCMCIA) card, a trusted platform module (TPM), a Hardware Security Module (HSM), a set-top box, a digital video recorder, a gaming console, a navigation device, a secure memory device with computational capabilities, a digital device with at least one tamper-resistant chip, an electronic device associated with an industrial control system, or an embedded computer in a machine, the machine comprising at least one of an airplane, a copier, a motor vehicle, or a microwave oven.

23. The method of claim 20, further including:
receiving the at least one input from the one or more users, the at least one input including at least one of a user interface selection on a network, a captured image, a voice command, a video, a freeform image and a handwritten image, wherein the at least one input conveys the emotion of the one or more users elicited by the media content.

24. The method of claim 20, wherein the generating the association further comprising:
analyzing the at least one input received to determine the emotion of the one or more users.

25. The method of claim 24, wherein the generating the set of measures includes generating images that represent the emotions.

26. The method of claim 24, further comprising:
classifying the at least one measure according to an audience category for a demographic of the one or more users; and
displaying, in a display component, the at least one measure of the set of measures with a weight indicator that provides a strength of the at least one measure to gauge an emotion response from the media content within the audience category.

27. The method of claim 24, further comprising:
categorizing a plurality of inputs into categories according to an audience demographic and rating measures of the set of measures with weight indicators according to a number of inputs received that are associated with the measures, wherein the at least one input comprises the plurality of inputs received from a plurality of users rating the media content.

28. The method of claim 27, further comprising:
associating the categories, the weight indicators, and the measures with the media content that comprises at least one of a video, an image, a graphical illustration, a voice media, a text, a software application, and an interactive media.

29. A computer readable storage medium comprising computer executable instructions that, in response to execution, cause a computing system including at least one processor to perform operations, comprising:
generating a set of measures corresponding to emotions that rate media content for one or more users with an electronic device;
prompting the one or more users to provide at least one input based on an emotion elicited by the media content;
generating an association of the at least one input with at least one measure of the set of measures; and
evaluating the media content according to the association.

30. The computer readable storage medium of claim 29, the operations further including:
receiving the at least one input from the one or more users, the at least one input including at least one of a user interface selection on a network, a captured image, a voice command, a video, a freeform image and a handwritten image, wherein the at least one input conveys the emotion of the one or more users elicited by the media content.

31. The computer readable storage medium of claim 29, the operations further including:
analyzing the at least one input received to determine the emotion of the one or more users.

32. The method of claim 24, wherein the generating the set of measures includes generating images that represent the emotions.

33. The method of claim 24, further comprising:
classifying the at least one measure according to an audience category for a demographic of the one or more users; and
displaying, in a display component, the at least one measure of the set of measures with a weight indicator that provides a strength of the at least one measure to gauge an emotion response from the media content within the audience category.

34. A system comprising:
means for generating a set of measures corresponding to emotions that rate media content for one or more users;
means for receiving an at least one input from the one or more users that indicates at least one emotion related to the media content;
means for associating the at least one input with at least one measure of the set of measures; and
means for evaluating the media content according to an output of the means for associating.

35. The system of claim 34, further comprising means for classifying the at least one measure according to an audience category for a demographic of the one or more users; and
means for displaying the at least one measure of the set of measures with a weight indicator that provides a strength of the at least one measure to gauge an emotion response from the media content within the audience category,
wherein the set of measures includes different images that indicate the emotions.
